(19) United States
(12) Patent Application Publication
(10) Pub. No.: US 2002/0066611 A1
(43) Pub. Date: Jun. 6, 2002

(54) Motorcycle vibration reduction apparatus

(76) Inventors: Larry Lane, Draper, UT (US); Paul Williams, Sandy, UT (US)

Correspondence Address: J. David Nelson, NELSON, SNUFFER, DAHLE & POULSEN, 10885 South State Street, Sandy, UT, 84070, US

(21) Appl. No.: 09/730,966

(22) Filed: Dec. 6, 2000

(51) Int. Cl. B62K 11/00; B62K 19/00

(52) U.S. Cl. 180/228; 180/219; 280/283

(57) ABSTRACT

This invention is an apparatus for increasing motorcycle riding comfort. It is particularly designed for use with Harley Davidson SofTail motorcycles. The engine and transmission are mounted on a main engine mount of the present invention which is attached to a pair of main engine vibration isolators which are bolted to an engine base plate. The engine base plate is welded to the bottom of the frame. The main engine vibration isolators allow longitudinal rocking of the engine and transmission while minimizing energy transfer to the frame. A front engine vibration isolator is affixed between a front engine anchor bracket, which is bolted to the engine, and a front engine mount bracket, which is welded to the front of the frame. This provides additional support to the engine while allowing the engine to rock with minimal energy transfer to the frame. A front hyme and a top hyme provide for obtaining and maintaining proper alinement of the engine and transmission. A pair of rear hymes prevent longitudinal displacement of the engine and transmission.

The installation of the engine vibration reducing components of the present invention requires the removal of the two stock shocks which are concealed beneath the engine and transmission. An air suspension system is used to replace the stock shock absorbers. An air bag is mounted between an air bag mount bracket, which is attached to the top rear of the frame, and an air bag compression plate, which is attached to the top front of the rear axle swing arm. Two oil bag brackets with vibration isolation replace the stock oil bag mount plate and two swing arm stops prevent excessive upward rotation of the swing arm. The oil bag brackets and the swing arm stops are bolted to the top rear frame beam.

### FIELD OF THE INVENTION

This invention relates to apparatuses for increasing motorcycle rider comfort, and in particular to apparatuses for reducing the transfer of engine vibration from motorcycle engine to motorcycle frame and for reducing road impact force transfer from rear axle to rider, and more particularly to apparatuses for reducing the transfer of engine vibration for the SOFTAIL® model of Harley-Davidson® (registered trademarks of the Harley-Davidson Company) motorcycles and motorcycles of similar design to a rider and for simultaneously reducing the transfer of road impact forces from the rear axle to the riders.

### BACKGROUND OF THE INVENTION

Motorcycles have been used for transportation and recreational riding since the beginning of motorized transportation. Various types of engine mounts have been devised in attempts to reduce the amount of vibration which is transmitted to the motorcycle frame. Depending on the size and design of the motorcycle, engine vibration transfer can be a source of major rider discomfort. The Harley-Davidson SofTail has been a very popular motorcycle design for many years. The SofTail design is used by Harley Davidson for the Fat Boy, the Heritage Classic and the SofTail models. However, despite the long time popularity of the SofTail design, these models suffer a substantial amount of engine vibration transfer to the frame and thus to the riders. This is true of other popular models of motorcycles for other brands.

U.S. Pat. No. 4,324,306 to Ishihara, U.S. Pat. No. 4,373,602 to Tomita, and U.S. Pat. No. 4,650,025 to Igarashi disclose motorcycle vibration reduction devices for use with frames that are either type “A: or type “U” which do not encircle the engine. These frames support engines by mounting only at the top and anterior of the engine. Several vibration reducing engine mounts and components of engine mounts have been designed for motorcycles with frames that are of either a type A or type U. Such frames are primarily designed for lightweight smaller motorcycles and do not offer support for under-engine mounting. Patented designs and components of engine mounts for A and U frames include orienting the engine along a horizontal axis with the frame or including rubber members in the engine mount as disclosed by Tashira. Tomita and Igarashi each disclose devices for transferring the vibration as rotational force. These devices are not and cannot be used for Harley-Davidson SofTail engine mounts as the SofTail utilizes a cage frame enclosing the entire engine and requires base support.

U.S. Pat. Nos. 4,412,597 and 4,392,542 to Alba, U.S. Pat. No. 4,465,157 to Onishi, and U.S. Pat. No. 4,487,285 to Tomita, disclose engine mounting apparatuses for frames that enclose the entire engine. Alba and Onishi disclose engine to frame connections incorporating crosswise rods or bolts with sleeves of rubber for vibration reduction. Tomita discloses an apparatus for engine vibration transfer for cage frame mounted engines which incorporates four links, each of which has two junctions of crosswise rods with rubber sleeves. While these apparatuses decrease the vibrations carried between the engine and the frame, the connections or links are still principally comprised of rigid metal members that transmit vibrations from the engine to the frame.

U.S. Pat. No. 4,641,810 to Ott discloses a motor mount which incorporates a connecting rod with a piston dampened by an elastomeric plug. U.S. Pat. No. 5,109,943 to Crenshaw discloses an apparatus which connects the top of each of twin cylinders to the motorcycle frame in an attempt to suppress vibration. U.S. Pat. No. 5,876,013 to Ott discloses a top mount apparatus which uses an elastomeric bushing between a mount member and a bracket to dampen vibration. These devices reduce the side-to-side motions of the engine by providing an additional support mount to the frame and use either an elastomeric and/or hydraulic piston to absorb vibrations. While these devices serve to reduce over all engine vibrations somewhat, they fail to sufficiently reduce vibrations because they transmit vibrations directly to the top of the frame where the rider's seat is attached.

U.S. Pat. No. 5,390,758 to Hunter, which is assigned to Harley Davidson, discloses another means for reducing the vibration transmitted from a motorcycle engine. This apparatus employs mounts that attach to the front and top of the engine with an additional mount at the pivot arm extending to the rear drive wheel. The mounts are comprised of crosswise pins or rods with housings of elastomeric members. Such mounts also do not sufficiently reduce engine vibrations because of the rider seat's proximity to the upper mount and the tendency of the pivot arm mount to transmit vibrations through the road suspension system.

U.S. Pat. No. 4,207,960 to Hashimoto utilizes mounting plates with flexibility or resiliency to reduce vibration transfer. This device provides some reduction for lateral vibration but does little for vibration along the axis of the motorcycle.

The apparatus of the present invention is specifically designed for use with a Harley-Davidson SofTail but it can be used for other motorcycles as well. The Harley-Davidson motorcycles which have the SofTail frame include the SofTail, the Fat Boy, and the Heritage Classic (all trademarks of the Harley-Davison Company). These motorcycles are very popular because of their classic appearance, but they suffer from the disadvantage of having the engine bolted directly to the frame with no vibration isolation. Hence the engine vibration is transmitted to the frame and thus to the operator.

The SOFTAIL was given its name by Harley-Davidson, allegedly due to the fact that the SOFTAIL mimics the appearance of the original Harley-Davidson “hard tail” frames but incorporated a suspension system with no visible suspension components. The SOFTAIL suspension system uses a swing arm and shock absorbers to attach to the rear wheel resulting in an improved cushioning against road vibrations. This suspension system gives the rider improved handling and riding comfort over the hard tail designs.

The standard SOFTAIL suspension system uses two shock absorber which are attached on one end to the main frame beneath the engine and extend horizontally under the engine to connect on the other end to the rear axle swing arm which is pivotally attached to the rear of the motorcycle frame. The SOFTAIL suspension system's principal feature is to isolate the rear wheel from the frame by means of the swing arm that pivots from the motorcycle frame. The rear wheel is thus allowed to move more independently from the motorcycle frame and road impact forces are dampened somewhat by the shock absorbers.

The two shock absorbers of the SOFTAIL suspension system attach to the main frame in parallel fashion to each another. One end of each shock absorber is attached to the main frame and the other is connected to a projection extending forward from the lower transverse cross member of the swing arm. The projection is adapted to receive a bolt or pin securing the shock absorber to the projection. The main frame of the motorcycle also hides the projection and shock absorbers consistent with the appearance of the Harley-Davidson “hard tail” frame.

Despite the improvements over the hard tail, the SOFTAIL suspension system has significant deficiencies. As discussed in U.S. Pat. No. 5,487,443 to Thurm (hereinafter the '443 patent), the maximum vertical movement of the rear wheel relative to the main frame is limited to 2 inches in either vertical direction before the swing arm contacts the frame. The shock absorbers of the SOFTAIL® suspension system allow the swing arm to move up and down only 0.75 inches in either direction from the center position. This is a result of the limitation imposed by the stock shock absorbers which allow only 0.25 inch displacement in either direction from the neutral position of the shock absorbers. Because of the proximity of the axis of the shock absorbers, in their concealed position beneath the engine and transmission the leverage ratio is 3.5 to 1. This very limited travel of the shock absorbers results in limited effectiveness and results in the transmission of road impact forces to the riders.

Further, the shock absorber's short range of motion requires continual and rapid oscillations of the shock absorber shaft according to the movement of the wheel. The directional change capacity of the shock absorbers is insufficient for a smooth ride . As mentioned in the '443 patent, the reluctance of the shock absorber to respond in rapid oscillation sufficiently is attributed to the relatively large momentum forces involved, the inertial drag caused by the movement of oil or gas within the shock absorber, and the frictional resistance caused by the seals and o-rings.

Attempts to improve the SOFTAIL suspension system have met with limited success. One technique to increase shock absorbency effectiveness was to increase the travel distance of the shock absorber. However, only modest improvements in ride of the motorcycle were realized because the technique fails to improve the responsiveness of the shock absorbers. In addition, the range of movement by the swing arm is limited by the motorcycle frame which also limits the range of travel distance of the shock absorber. Modifications to the motorcycle frame to accommodate a greater travel distance for the shock absorber spoil the “hard tail” appearance of the SOFTAIL. Other attempts have been made to improve the responsiveness of the shock absorbers, however, these attempts are hindered by the drag and friction forces.

Additional problems associated with the ride and handling of the standard SOFFAIL arise when motorcycle users lower the rear of the motorcycle. Such actions are undertaken to improve the aesthetic appearance of the motorcycle. Special kits are sold to allow the frame to be lowered. However, lowering the rear of the motorcycle reduces the stroke on the suspension and results in an even rougher ride.

A recent device described in U.S. Pat. No. 6,003,628 to Jurrens includes the use of an air-bag suspension unit. The air bag consists of an elastomeric material that is mounted inside a slidable housing between the lower transverse cross member of the swing arm and mounting brackets on the motorcycle main frame. The principal failings of this device arise from its location at the lower transverse cross member of the swing arm. This position inherently fails to address the vibrations directed at the rider's seat above the motorcycle's rear wheel. Also, the air-bag suspension system is difficult to retrofit and more expensive.

One objective of the present invention is to provide an apparatus for improving SofTail motorcycle riding comfort by reducing engine vibration transfer to the frame.

Another objective of the present invention is to provide an apparatus for improving SofTail motorcycle riding comfort by reducing rear tire road impact force transfer to the frame.

A further objective of the present invention is to provide an apparatus for improving SofTail motorcycle riding comfort which provides for an increase in the allowable travel of the rear axle in response to road impact forces.

A still further objective of the present invention is to provide an apparatus for improving SofTail motorcycle riding comfort which provides for adjustment of the height of the rear fender and the seat above the wheel.

A still further objective of the present invention is to provide an apparatus for improving SofTail motorcycle riding comfort which provides for easy adjustment of the suspension stiffness to match the weight and riding preferences of the riders.

A still further objective of the present invention is to provide an apparatus for improving SofTail motorcycle riding comfort which is not visible and does not alter the appearance of the SofTail.

A still further objective of the present invention is to provide an apparatus for improving SofTail motorcycle riding comfort which can be installed with minimal modifications to the frame of the motorcycle and with no modifications to the engine and other drive components of the motorcycle.

A still further objective of the present invention is to provide an apparatus for improving SofTail motorcycle riding comfort which can be readily installed by a motorcycle mechanic of ordinary skill with the assistance of a skilled welder.

A still further objective of the present invention is to provide an apparatus for improving SofTail motorcycle riding comfort which is economical.

### SUMMARY OF THE INVENTION

This invention is an apparatus for increasing motorcycle riding comfort. It is particularly designed for use with Harley Davidson SofTail motorcycles, but may be used with other motorcycles with similar frame and swing arm design.

In order to install the apparatus of the present invention, a number of minor modifications must be made to the standard frame and the standard swing arm of a SofTail or other motorcycle with similar frame and engine arrangement. The present invention also requires the removal of the stock shock absorbers, which are horizontally mounted to the bottom of the frame and the bottom of the swing arm, to allow the installation of the main engine base plate. The stock oil bag mount plate which is attached to the top rear frame beam must also be removed.

An air bag mount bracket is bolted to the rear of the top rear frame beam under the top flange of this angle iron shaped beam. An air bag compression plate is welded to the top front of the modified swing arm. An engine base plate is welded to the bottom of the frame. A rear hyme anchor bracket is welded to the engine base plate.

A front engine vibration isolator which is lined with elastomeric material is bolted to a front engine mount bracket which is welded to the front of the frame near the bottom of the frame. The front engine vibration isolator is sandwiched between the front engine mount bracket and a front engine anchor bracket, which is bolted to the front of the engine. The front engine anchor bracket is bolted to the front engine vibration isolator by a front mount bolt which passes through an elastomeric lined bolt receptacle of the front engine vibration isolator.

The main engine mount is connected by a pair of main engine vibration isolators to the engine base plate which is welded to the bottom of the frame. Each of the main engine vibration isolators are connected to the engine base plate by a pair of main engine anchor bolts, with the respective anchor bolts of each pair being on opposing sides of the main engine mount.

Two rear hymes connect the rear of the main engine mount to the rear hyme anchor bracket. The rear hymes prevent the longitudinal displacement of base of the engine and the transmission along the axis of the frame as the engine and transmission rock back and forth.

For preferred embodiments, proper engine axial alinement is obtained and maintained through use of a front hyme and a top hyme. The front hyme attaches to the front engine anchor bracket and a front hyme frame bracket, which is welded to the frame. The top hyme is attached on one end to a top hyme frame bracket, which is bolted to a top frame mount bracket, which is stock to a standard frame, and on the other end to a top hyme engine bracket which is anchored to the top of both cylinders respectively, of the engine.

The principal engine vibration is back and forth rocking of the engine and transmission. The rear hymes, the front engine mount vibration isolator, and the main engine vibration isolator permit the engine and transmission to rock forward and backward in this direction while minimizing the transfer of the energy of this motion from the engine to the frame. The configuration of the engine and the transmission are not altered by the present invention. The front hyme and the top hyme also allow free back and forth rocking of the engine and transmission while maintaining proper axial alinement with regard to the axis of the frame and minimizing vibration transfer to the frame.

As indicated above, the utilization of the present invention with the SofTail motorcycle necessitates the removal of the manufacturer's installed rear axle shock absorbers. For embodiments of the present invention utilized with the SofTail, the apparatus includes an air suspension system comprised of an air bag which is sandwiched between and affixed to an air bag mount bracket which is connected to the top rear frame beam and an air bag compression plate which is welded to the top front of the swing arm.

The inflation pressure of the air bag may be manually adjusted or may be monitored and controlled by a mechanized air bag pressure control system. The air bag is connected to an electric air pump, which is mounted to the frame of the motorcycle, and a pressure gauge, control switch and control valve which are mounted on top of the tanks or in another appropriate instrument position. Other systems for the control of the air bag pressure will be known to persons skilled in the art.

This air suspension system provides for a substantial increase in the amount of allowable travel of the rear axle as road impact forces are encountered. The suspension system can be adjusted for the weight of the occupants and the suspension stiffness desired by the operator. This reduces bottoming out of the rear axle. The air suspension system has none of the delayed response, drag and friction problems of the standard shock absorbers. The leverage ratio is also improved from 3.5:1 to 1.5:1.

The installation of the air bag mount bracket requires the removal of the stock oil bag mount plate which is bolted to the top rear frame beam and which holds the oil bag in place. The present invention includes a pair of oil bag mount brackets which attach to the top rear frame beam and secure the oil bag. The oil bag mount bracket installation incorporates an oil bag vibration isolator of resilient material to reduce vibration transfer from the oil bag, which is linked to the engine, to the frame.

The present invention also requires the replacement of the stock supports for the upper exhaust pipe and the lower exhaust pipe. A lower exhaust pipe bracket, an upper exhaust pipe front bracket, and an upper exhaust pipe rear bracket of the present invention anchor the exhaust pipes.

The installation of the air bag compression plate requires the removal of a portion of the top of the stock rear tire dust plate. The modified dust plate is attached to the bottom of the air bag compression plate.

A pair of swing arm stop installations, which are each comprised of a swing arm stop and a stop mount block, are bolted to the top rear frame beam. They are installed so that the swing arm stops will contact the top front of the swing arm as the swing arm rotates forward to its forward most allowable position. These stop installations prevent excessive forward rotation of the swing arm, thereby preventing contact between the top front of the swing arm and the top rear of the frame.

### BRIEF DESCRIPTION OF THE DRAWINGS

FIG. 1 is a side view perspective showing the components of a preferred embodiment of the present invention and the installation configuration for the components.

FIG. 2 is a side view perspective showing the modifications to a standard SofTail frame required for installation of the present invention.

FIG. 3 is a side view perspective of an installed main engine mount of the present invention.

FIG. 4 is a perspective detail of a main engine mount of the present invention.

FIG. 5 is a side view perspective detail of a front engine mount bracket, front vibration isolation, and front engine mount of the present invention.

FIG. 6 is a side view perspective detail of a front hyme installation of the present invention.

FIG. 7 is a front view detail of an air bag mount bracket of the present invention.

FIG. 8 is a side view detail of an air bag mount bracket of the present invention.

FIG. 9 is a front view detail of an air bag compression plate of the present invention.

FIG. 10 is a bottom view cross section detail of an air bag compression plate of the present invention.

FIG. 11 is a front view exploded perspective detail showing the installation configuration of an air bag, air bag mount bracket, air bag compression plate, oil bag mount brackets, swing arm stops, and modified dust plate of the present invention.

FIG. 12 is a top view detail of one end of a main engine vibration isolator, including a main engine anchor bolt, anchor bolt vibration isolator, engine mount bolt collar and anchor bolt sleeve.

FIG. 13 is a side view cross section detail of a main engine vibration isolator, including a main engine anchor bolt, anchor bolt vibration isolator, engine mount bolt collar and anchor bolt sleeve.

FIG. 14 is a side view perspective of a top hyme installation of the present invention.

FIG. 15 is a side view elevation of the rear hyme anchor bracket of the present invention.

FIG. 16 is a rear view elevation of the rear hyme anchor bracket of the present invention.

FIG. 17 is a side view detail of an oil bag mount bracket of the present invention.

FIG. 18 is a side view perspective detail of a lower exhaust pipe bracket installation of the present invention.

FIG. 19 is a side view perspective detail of an upper exhaust pipe front bracket installation of the present invention.

FIG. 20 is a side view perspective detail of an upper exhaust pipe rear bracket installation of the present invention.

FIG. 21 is an illustration of an air supply, distribution and control system for the air suspension system of the present invention.

FIG. 22 is a side view perspective detail of a swing arm stop installation of the present invention.

### DETAILED DESCRIPTION OF PREFERRED EMBODIMENTS

Referring first to FIG. 2, a number of modifications must be made to the standard frame 1 and the standard swing arm 2 of a SofTail or other motorcycle with similar frame and engine arrangement to accommodate the apparatus of the present invention. Standard frame components 3 and the swing arm components 4 that must be removed for the installation of preferred embodiments of the apparatus of the present invention are shown.

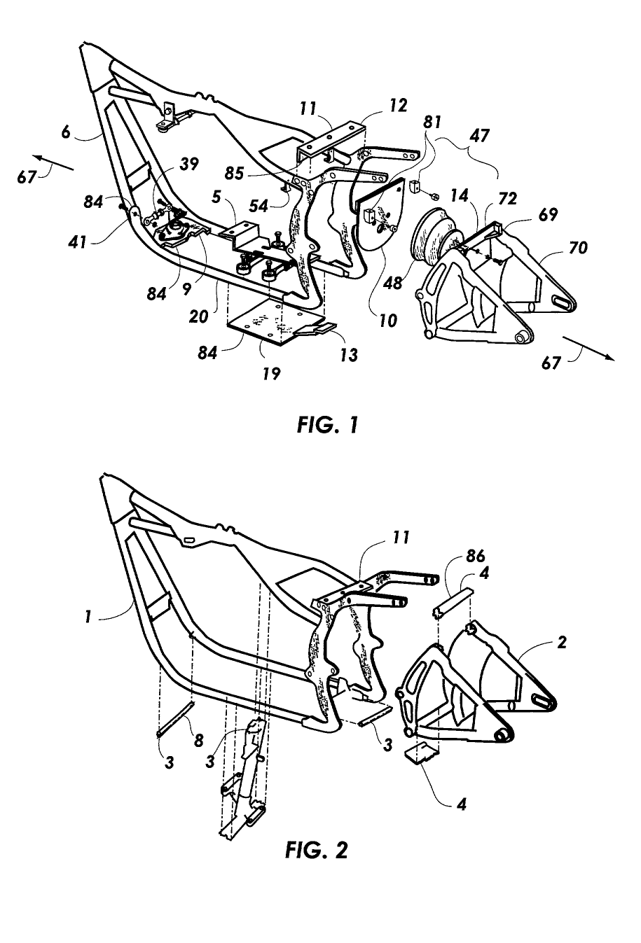

Referring now to FIG. 1. the frame additions 84 and the swing arm additions 72 for preferred embodiments of the apparatus of the present invention are shown. The present invention also requires the removal of the stock shock absorbers, which are horizontally mounted to the bottom of the frame and the bottom of the swing arm, and the stock oil bag mount plate which is attached to the top rear frame beam 11.

The modified frame 6 of the present invention is shown along with the installation configuration of the other components of the apparatus of the present invention. As indicated above, the stock shock absorbers, which are concealed beneath the engine and transmission for the stock SofTail, in order to give the SofTail the look of a HardTail, must be removed for the installation of the vibration reducing main engine mount 5 of the present invention. Referring again also to FIG. 2, the bottom front cross bar 8 of the standard frame is removed and a front engine mount bracket 9 is welded to the frame in the position shown in FIG. 1. An air bag mount bracket 10 is bolted to the rear 85 of the top rear frame beam 11 under the top flange 12 of this angle iron shaped beam. The top front swing arm cross bar 86 is removed and an air bag compression plate 14 is welded to the top front 69 of the modified swing arm 70. An engine base plate 19 is welded to the bottom 20 of the frame. A rear hyme anchor bracket 13 is welded to the engine base plate.

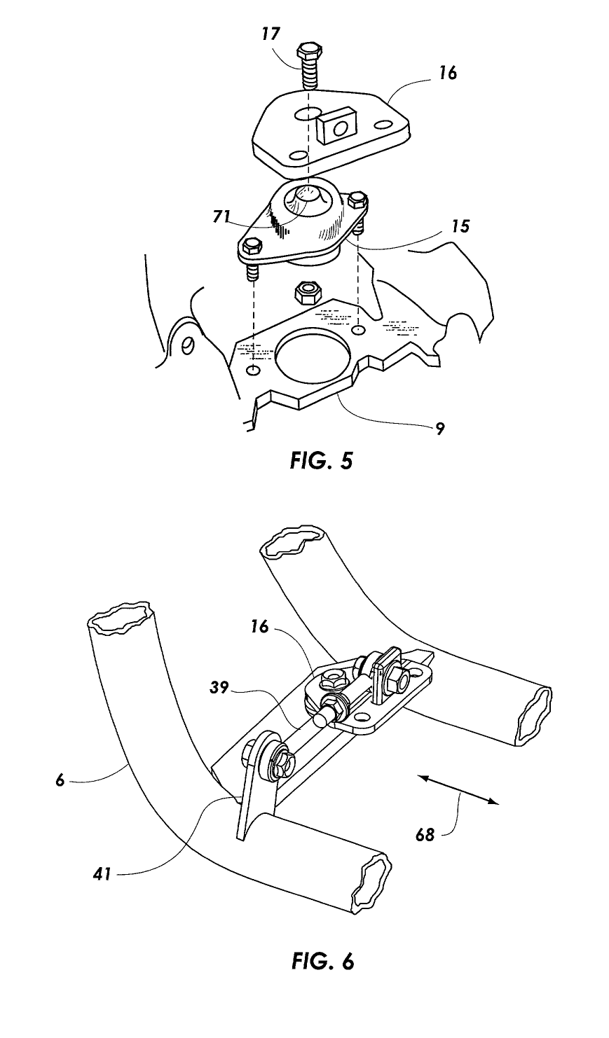

Referring now to FIG. 5, for preferred embodiments, a front engine vibration isolator 15 which is lined with elastomeric material is bolted to the front engine mount bracket 9 and is sandwiched between the front engine mount bracket and the front engine anchor bracket 16 which is bolted to the front of the engine. The front engine anchor bracket is bolted to the front engine vibration isolator by a front mount bolt 17 which passes through an elastomeric lined bolt receptacle 71 of the front engine vibration isolator.

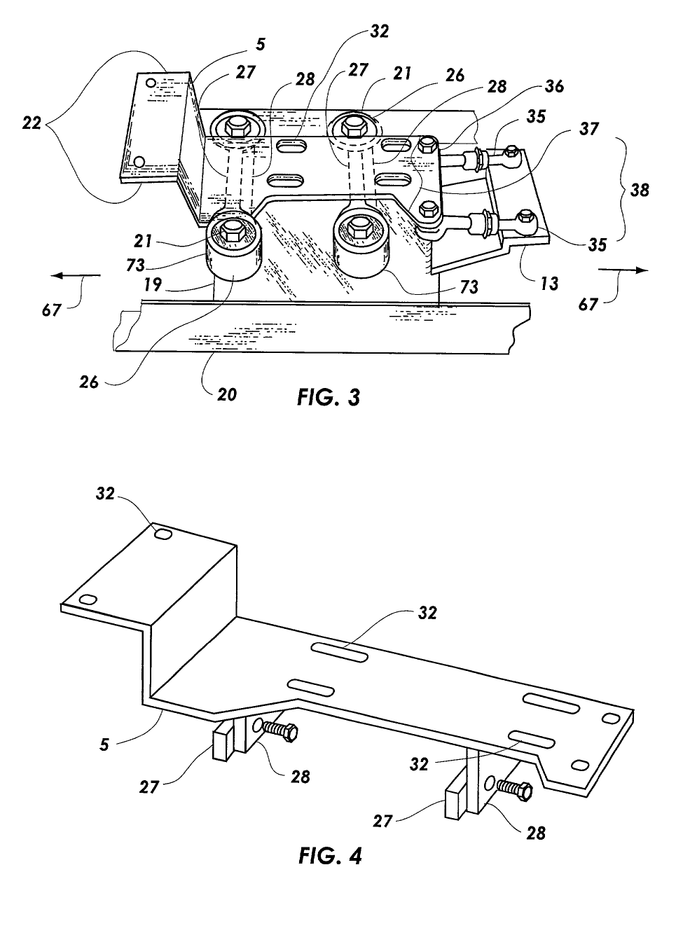

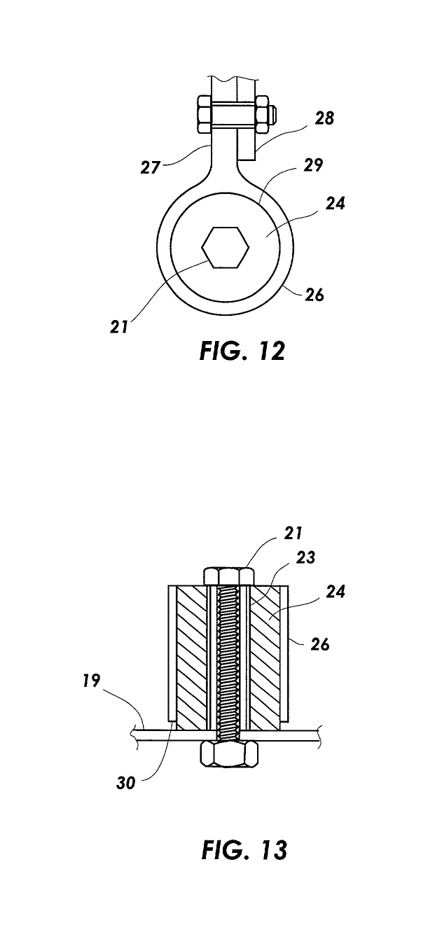

Referring now to FIGS. 3 and 4, the main engine mount 5 is connected by a pair of main engine vibration isolators 73 to the engine base plate 19 which is welded to the bottom 20 of the frame. Each of the main engine vibration isolators are connected to the engine base plate by a pair of main engine anchor bolts 21, with the respective anchor bolts of each pair being on opposing sides 22 of the main engine mount. Referring also to FIGS. 12 and 13, each of the main engine anchor bolts is inserted through an anchor bolt sleeve 23 which is encased in an anchor bolt vibration isolator 24 which is formed of resilient material. An engine mount bolt collar 26 encloses and engages each anchor bolt vibration isolator respectively. The respective engine mount bolt collars of each pair of main engine anchor bolts are connected to the other by an engine mount bolt collar cross bar 27. The engine mount bolt collar cross bars are bolted to respective main engine mount anchor bars 28 on the bottom of the main engine mount. The engine mount bolt collars and the vibration isolators may have a cylindrical shape 29 as shown in FIGS. 3 and 12, or may have any of a number of shapes. The anchor bolt vibration isolators extend below the bottom 30 of the engine mount bolt collars to prevent vibration transfer from the engine mount bolt collars to the engine base plate.

Engine bolts pass through engine bolt openings 32 in the engine mount and engage the engine and the transmission in the manufacturer's standard threaded engine anchor bolt receptacles which are used by the manufacturer to secure the engine to the frame.

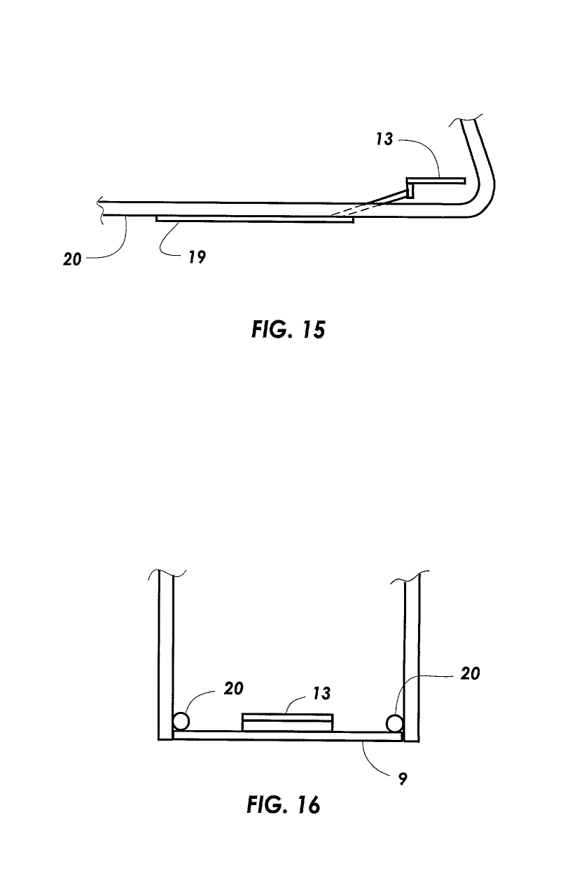

Referring further to FIG. 3 and also to FIGS. 15 and 16, two rear hymes 35 connect the rear 36 of the main engine mount to the rear hyme anchor bracket 13. The respective rear hymes connect to opposing sides 37 of the rear of the main engine mount and extend rearward to corresponding opposing sides 38 of the rear hyme anchor bracket. The rear hymes prevent the longitudinal displacement of base of the engine and the transmission along the axis 67 of the frame (refer to FIG. 1) as the engine and transmission rock back and forth 31 as shown in FIG. 14.

For preferred embodiments, proper engine axial alinement 68 is obtained and maintained through use of a front hyme 39 which is as shown in FIG. 6 and a top hyme 40 which is shown in FIG. 14. The front hyme attaches to the front engine anchor bracket 16, which is a stock item for most preferred embodiments, and a front hyme frame bracket 41 of the present invention, as shown in FIG. 6, which is welded to the frame 6. The top hyme is attached on one end to a top hyme frame bracket 42 of the present invention, which is bolted to a top frame mount bracket 33, which is stock to a standard frame, and on the other end to a top hyme engine bracket 43, which is anchored to the top of both cylinders 44 respectively, of the engine.

The principal engine vibration is back and forth rocking 31 of the engine and transmission as shown in FIG. 14. The rear hymes, the front engine mount vibration isolator, and the main engine vibration isolator permit the engine and transmission to rock forward and backward in this direction while minimizing the transfer of the energy of this motion from the engine to the frame. The configuration of the engine 45 and the transmission are not altered by the present invention. The front hyme and the top hyme also allow free back and forth rocking of the engine and transmission while maintaining proper axial alinement with regard to the axis of the frame and minimizing vibration transfer to the frame.

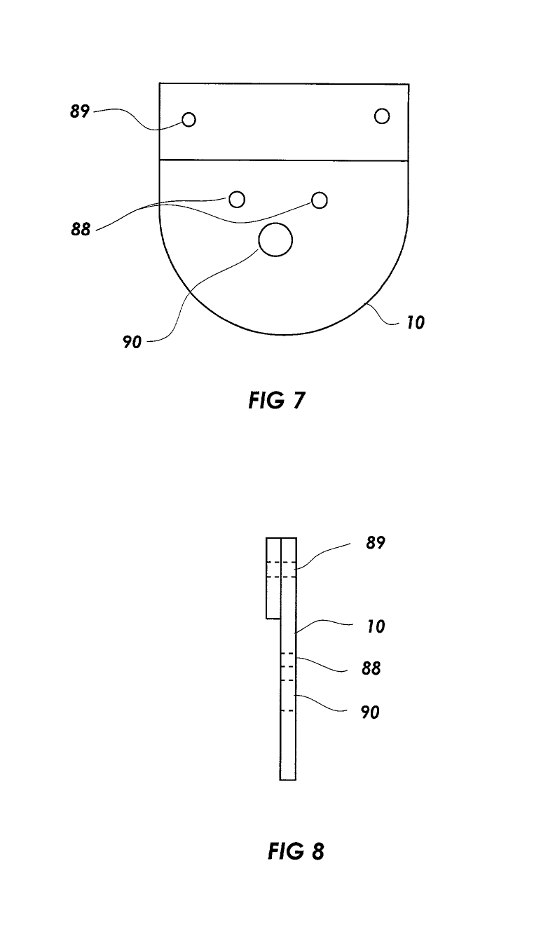

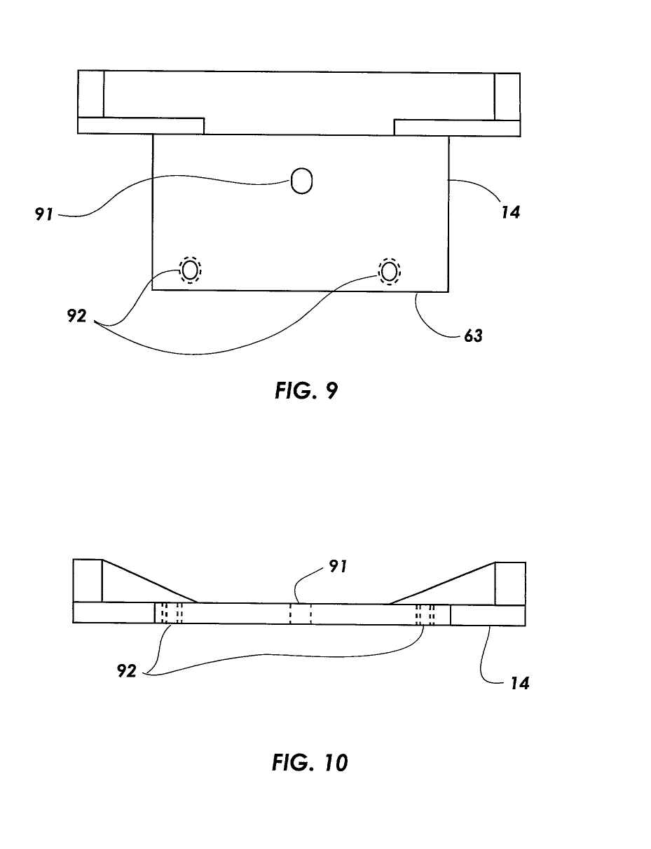

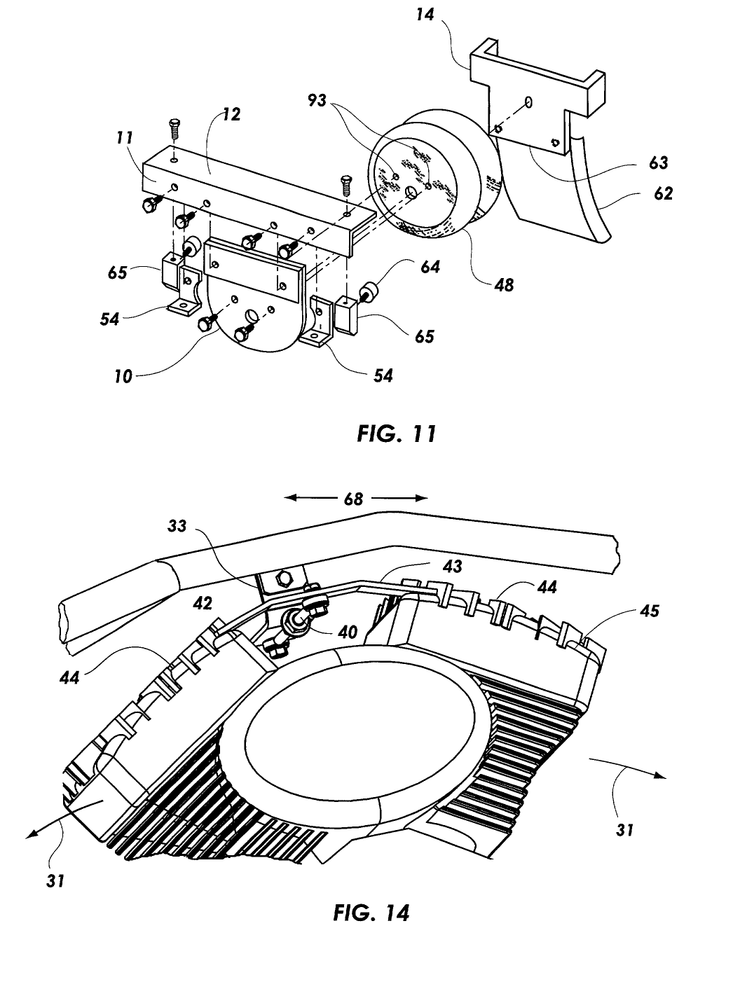

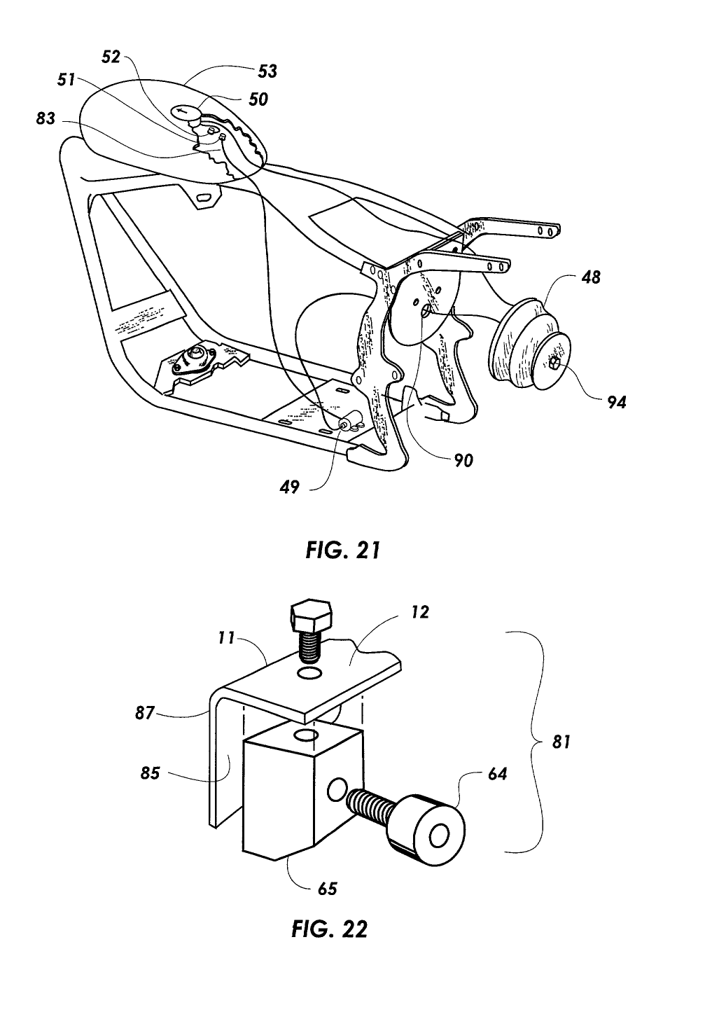

As indicated above, the utilization of the present invention with the SofTail motorcycle necessitates the removal of the manufacturer's installed rear axle shock absorbers. This may not be necessary with other makes and models of motorcycles. Referring now to FIGS. 1 and 11, for embodiments of the present invention utilized with the SofTail, the apparatus includes an air suspension system 47 comprised of a rear air bag 48 which is sandwiched between and affixed to an air bag mount bracket 10 which is connected to the top rear frame beam 11 and an air bag compression plate 14 which is welded to the top front 69 of the swing arm. FIGS. 7 and 8 show a preferred embodiment of the air bag mount bracket. FIGS. 9 and 10 show a preferred embodiment of the air bag compression plate. The air bag is bolted to the air bag compression plate by a bolt which is inserted through an air bag compression plate bolt receptacle 91 into the air bag rear bolt receptacle 94 as shown in FIG. 21, which is typically integral to the air bag.

Referring to FIGS. 7 and 8, for preferred embodiments the air bag is bolted to the air bag mount bracket by bolts inserted through air bag bracket bolt receptacles 88 into air bag bolt receptacles 93 in the air bag as shown in FIG. 11. The air bag mount bracket is bolted to the top rear frame beam by bolts inserted through air bag mount frame bolt receptacle 89. Air is supplied to the air bag through the air bag mount air orifice 90. See also FIG. 21.

The inflation pressure of the air bag may be manually adjusted or may be monitored and controlled by a mechanized air bag pressure system 83 as shown in FIG. 21. The air bag 48 is connected to an electric air pump 49, which is mounted to the frame of the motorcycle, and a pressure gauge 50, control switch 51 and control valve 52 which are mounted on top of the tanks 53 or in another appropriate instrument position. Other systems for the control of the air bag pressure will be known to persons skilled in the art.

This air suspension system provides for a substantial increase in the amount of allowable travel of the rear axle as road impact forces are encountered. The suspension system can be adjusted for the weight of the occupants and the suspension stiffness desired by the operator. This reduces bottoming out of the rear axle. The air suspension system has none of the delayed response, drag and friction problems of the standard shock absorbers. The leverage ratio is also improved from 3.5:1 to 1.5:1.

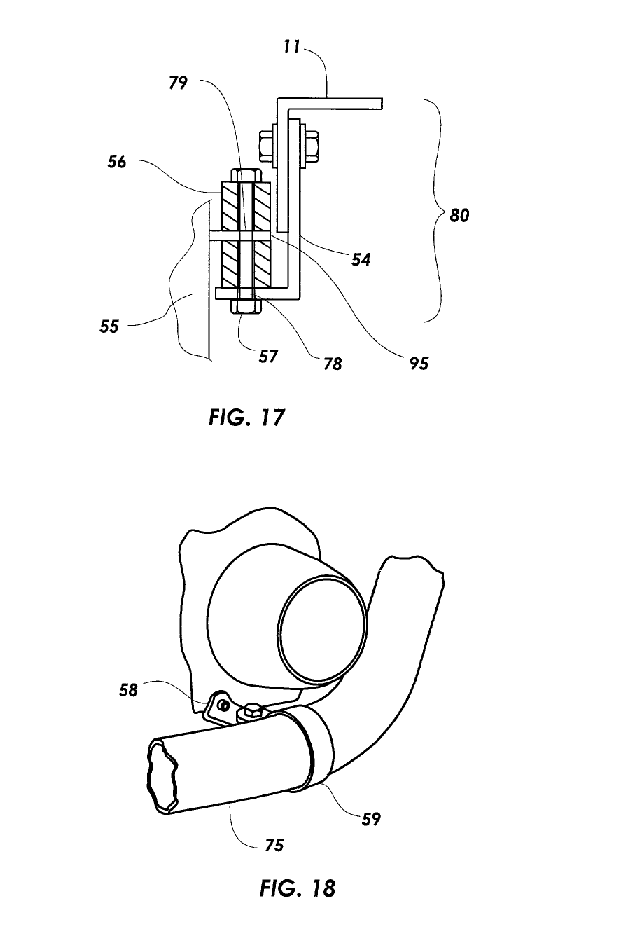

Referring to FIG. 1, 11 and 17, the installation of the air bag mount bracket requires the removal of the stock oil bag mount plate which is bolted to the top rear frame beam and which holds the oil bag in place. The present invention includes a pair of oil bag mount brackets 54 which attach to the top rear frame beam 11 and secure the oil bag 55. The oil bag mount bracket installation 80 incorporates an oil bag vibration isolator 56 of resilient material through which oil bag anchor bolts 57 are inserted to reduce vibration transfer from the oil bag, which is linked to the engine, to the frame. The oil bag vibration isolators are affixed on the oil bag anchor bolts respectively between the oil bag bracket bolt receptors 78 and the oil bag bolt receptors 79 in the oil bag anchor bracket 95. The oil bag vibration isolators may also extend above the oil bag anchor bracket, as shown in FIG. 17, to better isolate the oil bag mount bracket from the oil bag.

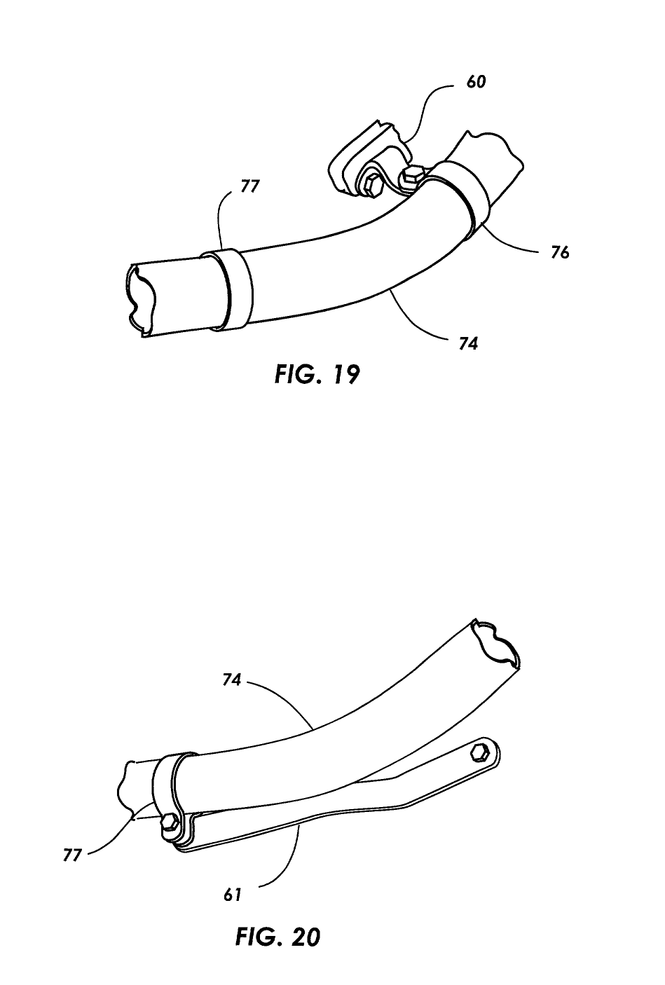

Referring now to FIGS. 18, 19 and 20, the present invention also requires the replacement of the stock supports for the upper exhaust pipe 74 and the lower exhaust pipe 75. Referring to FIG. 18, a lower exhaust pipe bracket 58 of the present invention anchors the lower exhaust pipe bracket ring 59 to the engine. Referring to FIG. 19 and FIG. 20, an upper exhaust pipe front bracket 60 and an upper exhaust pipe rear bracket 61 anchor the upper exhaust pipe to the engine by attachment to the upper exhaust pipe front ring 76 and the upper exhaust pipe rear ring 77.

The installation of the air bag compression plate requires the modification of the stock dust plate. Referring to FIG. 11 and FIG. 9, the modified dust plate 62, which has the top portion removed, is attached to the bottom 63 of the air bag compression plate by bolts inserted through dust plate bolt receptors 92 in the bottom of the air bag compression plate.

Referring now to FIGS. 1, 11 and 22, a pair of swing arm stop installations 81, which are each comprised of a swing arm stop 64 and a stop mount block 65, which is bolted to the top rear frame beam 11. The swing arm stop installations are mounted behind the rear 85 of the top rear frame beam and beneath the top flange 12 near the respective ends 87 of the beam. They are installed so that the swing arm stops will contact the top front of the swing arm as the swing arm rotates forward to its forward most allowable position. These stop installations prevent excessive forward rotation of the swing arm, thereby preventing contact between the top front of the swing arm and the top rear of the frame. One swing arm stop installation is affixed on each end of the top rear frame beam. Each swing arm stop is affixed to a stop mount block which is attached to the top rear frame beam by a stop mount bolt.

Variations and other embodiments of the present invention may not utilize the front engine mount bracket, front engine vibration isolator, and front engine anchor bracket. For those embodiments, the main engine mount provides most of the support and stability for the engine and transmission. While the embodiment shown in the figures includes only two main engine vibration isolators, more than two main engine vibration isolators may be used. Other embodiments may not utilize some or all of the hymes shown for the preferred embodiments, namely the rear hymes, the top hyme and the front hyme.

Other embodiments of the invention and other variations and modifications of the embodiments described above will be obvious to a person skilled in the art. Therefore, the foregoing is intended to be merely illustrative of the invention and the invention is limited only by the following claims.

What is claimed is:

1. Apparatus for improving riding comfort for riders of a SofTail motorcycle or other motorcycle with a similar frame and rear axle swing arm comprising:
a) engine base plate affixed to the frame of the motorcycle;
b) two or more main engine vibration isolators affixed to the engine base plate; and
c) main engine mount affixed to the main engine vibration isolators, the engine and transmission of the motorcycle being affixed to the main engine mount.

2. Apparatus as recited in claim 1 further comprising:
a) front engine mount bracket affixed to the frame;
b) front engine anchor bracket affixed to the engine;
c) front engine vibration isolator affixed to the front engine mount bracket between the front engine mount bracket and the front engine anchor bracket; and
d) front mount bolt which affixes the front engine anchor bracket to the front engine vibration isolator.

3. Apparatus as recited in claim 1 further comprising a rear hyme anchor bracket affixed to the engine base plate and one or more rear hymes which connect the rear of the main engine mount to the rear hyme anchor bracket.

4. Apparatus as recited in claim 1 further comprising a front hyme frame bracket affixed to the frame and a front hyme which connects the front engine anchor bracket to the front hyme frame bracket.

5. Apparatus as recited in claim 1 wherein the frame has a top frame mount bracket and the apparatus further comprises a top hyme frame bracket affixed to the top frame mount bracket, a top hyme engine bracket affixed to the top of both cylinders of the engine, and a top hyme which connects the top hyme frame bracket and the top hyme engine bracket.

6. Apparatus as recited in claim 1 wherein the frame has a top rear frame beam, the apparatus further comprising an air bag, an air bag mount bracket affixed to the top rear frame beam, and an air bag compression plate affixed to the top front of the swing arm, the air bag being affixed between the air bag mount plate and the air bag compression plate.

7. Apparatus as recited in claim 6 further comprising an air bag pressure control system.

8. Apparatus as recited in claim 6 further comprising a pair of oil bag mount installations affixing the oil bag to the top rear frame beam, each oil bag mount installation comprising an oil bag mount bracket, an oil bag vibration isolator, and an oil bag anchor bolt, the oil bag mount bracket having an oil bag bracket bolt receptor, the oil bag vibration isolator being inserted on the oil bag anchor bolt between the oil bag bracket bolt receptor and an oil bag bolt receptor on the oil bag.

9. Apparatus as recited in claim 6 further comprising a pair of swing arm stop installations affixed to the top rear frame beam, each swing arm stop installation comprising a swing arm stop and a stop mount block which affixes the swing arm stop to the top rear frame beam.

10. Apparatus as recited in claim 1 further comprising a lower exhaust pipe bracket, an upper exhaust pipe front bracket, and an upper exhaust pipe rear bracket.

11. Apparatus as recited in claim 6 further comprising a modified dust plate affixed to the air bag compression plate.

12. Apparatus for improving riding comfort for riders of a SofTail motorcycle or other motorcycle with a similar frame and rear axle swing arm, the frame having a top rear frame beam, the apparatus comprising:
a) air bag mount bracket affixed to the top rear frame beam;
b) air bag compression plate affixed to the top front of the swing arm; and
c) air bag affixed between the air bag mount plate and the air bag compression plate.

13. Apparatus as recited in claim 12 further comprising an air bag pressure control system.

14. Apparatus as recited in claim 12 further comprising a pair of oil bag mount installations affixing the oil bag to the top rear frame beam, each oil bag mount installation comprising an oil bag mount bracket, an oil bag vibration isolator, and an oil bag anchor bolt, the oil bag mount bracket having an oil bag bracket bolt receptor, the oil bag vibration isolator being inserted on the oil bag anchor bolt between the oil bag bracket bolt receptor and an oil bag bolt receptor on the oil bag.

15. Apparatus as recited in claim 12 further comprising a pair of swing arm stop installations affixed to the top rear frame beam, each swing arm stop installation comprising a swing arm stop and a stop mount block which affixes the swing arm stop to the top rear frame beam.

16. Apparatus for improving riding comfort for riders of a SofTail motorcycle or other motorcycle with a similar frame and rear axle swing arm, the apparatus comprising vibration reducing means for reducing engine vibration transfer to the motorcycle frame.

17. Apparatus as recited in claim 16 wherein the vibration reducing means comprises:
a) engine base plate affixed to the frame of the motorcycle;
b) two or more main engine vibration isolators affixed to the engine base plate; and
c) main engine mount affixed to the main engine vibration isolators, the engine and transmission of the motorcycle being affixed to the main engine mount.

18. Apparatus as recited in claim 17 wherein the vibration reducing means further comprises:
a) front engine mount bracket affixed to the frame;
b) front engine anchor bracket affixed to the engine;
c) front engine vibration isolator affixed to the front engine mount bracket between the front engine mount bracket and the front engine anchor bracket; and
d) front mount bolt which affixes the front engine anchor bracket to the front engine vibration isolator.

19. Apparatus as recited in claim 17 wherein the vibration reducing means further comprises a rear hyme anchor bracket affixed to the engine base plate and one or more rear hymes which connect the rear of the main engine mount to the rear hyme anchor bracket, the rear hymes preventing longitudinal displacement of the engine and transmission.

20. Apparatus as recited in claim 17 wherein the vibration reducing means further comprises a front hyme frame bracket affixed to the frame and a front hyme, the front hyme connecting the front hyme frame bracket to the front engine anchor bracket and providing for obtaining and maintaining axial alinement for the engine and transmission.

21. Apparatus as recited in claim 17 wherein the frame has a top frame mount bracket and the vibration reducing apparatus further comprises a top hyme frame bracket affixed to the top frame mount bracket, a top hyme engine bracket affixed to the top of both cylinders of the engine, and a top hyme which connects the top hyme frame bracket and the top hyme engine bracket, the top hyme providing for obtaining and maintaining axial alinement for the engine and transmission.

22. Apparatus as recited in claim 16 further comprising road impact reducing means which replaces stock shock absorbers removed for installation of the vibration reducing means, the road impact reducing means comprising an air bag affixed between the top rear of the frame and the top front of the swing arm.

23. Apparatus as recited in claim 22 wherein the frame has a top rear frame beam, and the road impact reducing means further comprises an air bag mount bracket affixed to the top rear frame beam and an air bag compression plate affixed to the top front of the swing arm, the air bag being affixed to the air bag mount bracket and the air bag compression plate between the air bag mount bracket and the air bag compression plate.

24. Apparatus as recited in claim 22 further comprising an air bag pressure control system.

25. Apparatus as recited in claim 23 further comprising a pair of oil bag mount installations affixing the oil bag to the top rear frame beam, each oil bag mount installation comprising an oil bag mount bracket, an oil bag vibration isolator, and an oil bag anchor bolt, the oil bag mount bracket having an oil bag bracket bolt receptor, the oil bag vibration isolator being inserted on the oil bag anchor bolt between the oil bag bracket bolt receptor and an oil bag bolt receptor on the oil bag.

26. Apparatus as recited in claim 23 further comprising a pair of swing arm stop installations affixed to the top rear frame beam, each swing arm stop installation comprising a swing arm stop and a stop mount block which affixes the swing arm stop to the top rear frame beam.

27. Apparatus as recited in claim 16 further comprising a lower exhaust pipe bracket, an upper exhaust pipe front bracket, and an upper exhaust pipe rear bracket.

28. Apparatus as recited in claim 23 further comprising a modified dust plate affixed to the air bag compression plate.

29. Apparatus for improving riding comfort for riders of a SofTail motorcycle or other motorcycle with a similar frame and rear axle swing arm, the apparatus comprising road impact reducing means for reducing rear tire road impact force transfer to the riders.

30. Apparatus as recited in claim 29 wherein the road impact reducing means comprises an air bag affixed between the top rear of the frame and the top front of the swing arm.

31. Apparatus as recited in claim 30 wherein the frame has a top rear frame beam, and the road impact reducing means further comprises an air bag mount bracket affixed to the top rear frame beam and an air bag compression plate affixed to the top front of the swing arm, the air bag being affixed to the air bag mount bracket and the air bag compression plate between the air bag mount bracket and the air bag compression plate.

32. Apparatus as recited in claim 30 further comprising an air bag pressure control system.

33. Apparatus as recited in claim 31 further comprising a pair of oil bag mount installations affixing the oil bag to the top rear frame beam, each oil bag mount installation comprising an oil bag mount bracket, an oil bag vibration isolator, and an oil bag anchor bolt, the oil bag mount bracket having an oil bag bracket bolt receptor, the oil bag vibration isolator being inserted on the oil bag anchor bolt between the oil bag bracket bolt receptor and an oil bag bolt receptor on the oil bag.

34. Apparatus as recited in claim 31 further comprising a pair of swing arm stop installations affixed to the top rear frame beam, each swing arm stop installation comprising a swing arm stop and a stop mount block which affixes the swing arm stop to the top rear frame beam.

35. Apparatus as recited in claim 29 further comprising a lower exhaust pipe bracket, an upper exhaust pipe front bracket, and an upper exhaust pipe rear bracket.

36. Apparatus as recited in claim 31 further comprising a modified dust plate affixed to the air bag compression plate.
